(19) United States
(12) Patent Application Publication
(10) Pub. No.: US 2026/0244637 A1
(43) Pub. Date: Aug. 20, 2026

(54) SYSTEM, A CLOUD PLATFORM AND A METHOD FOR MANAGING CONFIGURATION ITEMS

(71) Applicant: Trianz Digital Consulting Private Limited, Bangalore South (IN)

(72) Inventors: Srikanth Rao Manchala, Bangalore South (IN); Anil Kumar Gupta, Bangalore South (IN); Kalpana Mandloi, Bangalore South (IN); Musunuri Balaram Prasad, Bangalore South (IN); Thokala Sarat Babu, Bangalore South (IN); Rimli Sur, Bangalore South (IN)

(73) Assignee: Trianz Digital Consulting Private Limited, Bangalore South (IN)

(21) Appl. No.: 19/642,775

(22) Filed: Apr. 9, 2026

(30) Foreign Application Priority Data
May 20, 2025 (IN) 202541048488

(51) Int. Cl. G06F 16/25; G06F 16/28

(52) U.S. Cl. CPC G06F 16/254; G06F 16/285

(57) ABSTRACT

The invention includes a system (100), a cloud platform (200), and a method (300) for managing Configuration Items (12a). Current CI management methods/systems are inefficient due to human error. An extraction module (120/120b) extracts relevant data from the infrastructure (I1) or user input (130). A transformation layer (140) converts this data (D1) into transformed data (D2) using static or configurable mapping rules. A modelling layer (160) with classification rules and processing instructions identifies and classifies CIs. A bucketing layer (180) compares transformed data (D2) with classifications and stores the data (D3) in related storage pockets (102a). In one more embodiment of the invention, the bucketing layer assigns unique identifier (UID) to each compared CI and forms datasets (Ds1) with classified CIs (12a, 12b). The invention automates data extraction and transformation, reducing human error and increasing management efficiency.

### CROSS-REFERENCE TO RELATED APPLICATIONS

Benefit is claimed to Indian Patent Application No. IN 202541048488, filed on May 20, 2025, the contents of which are incorporated by reference herein in their entirety.

### FIELD OF THE INVENTION

The present invention relates to managing configuration items of computing environments. More specifically, the present invention relates to a system and a method of managing configuration items of information technology (IT) infrastructure of computing environments including various cloud platforms and On-prem servers or services.

### BACKGROUND FOR THE INVENTION:

A configuration item (CI) is any component within a computing environment that needs to be managed to ensure a system's (computing) functionality. This can include hardware, software, documentation, or any other element that is part of the IT infrastructure.

An IT (Information technology) infrastructure comprises various configuration items (CI's) essential for its operation and management. These include physical and virtual servers, which host applications and services, and network devices like routers, switches, and firewalls that facilitate communication. Storage devices such as SANs (Storage Area Network) and NAS (Network Attached Storage) provide data storage solutions, while software applications and databases ensure functionality and data management. Workstations, including desktops and laptops, are used by end-users, and cloud services offer scalable resources. Peripheral devices like printers and scanners are also part of configuration items. Each of these items must be accurately tracked and managed to ensure a seamless and efficient IT environment.

Management of Configuration Items (CIs) involves systematically managing all components within a computing environment to ensure their proper functioning and integration. This includes tracking, controlling, and maintaining hardware, software, documentation, and other elements.

The process of managing a CI includes identifying and cataloguing all CIs to ensure they are accounted for and can be tracked. The managing activities include implementing control processes to manage changes to CIs, maintaining system integrity, and preventing unauthorized modifications. “Status accounting” is another crucial activity, which involves recording and reporting the status of CIs throughout their lifecycle, providing visibility into their current state and history. Additionally, maintenance activities are performed to keep components up-to-date and functioning optimally. These activities collectively ensure that configuration items are effectively managed, contributing to the overall stability and efficiency of the computing environment.

The management of Configuration Items (CIs) is closely related to the Configuration Management Database (CMDB), which serves as a centralized repository for storing information about CIs and their relationships. Effective CI management ensures that all components are accurately identified, controlled, and maintained, which is essential for the integrity of the CMDB. By implementing processes for status accounting, verification, and maintenance, organizations can ensure that the CMDB remains up-to-date and dependable. This, in turn, enhances the ability to track changes, manage configurations, and support decision-making processes within the IT environment, contributing to overall system stability and efficiency.

Current technologies (Prior art) for managing configuration items (CIs) face several significant challenges. One major issue is the reliance on manual processes for extracting and transforming data, which can be time-consuming and prone to human error. This often leads to inconsistent classification and storage of CIs, making data retrieval and management difficult. Additionally, many prior art systems of managing CIs lack flexibility and scalability, struggling to adapt to evolving infrastructure and growing data needs. The complexity of managing multiple IT environments, such as cloud, on-premises, and hybrid setups, further complicates the process, as each environment may require different handling and integration methods.

Current technologies (prior art) (methods/systems) often lack flexibility in managing Configuration Items (CIs), requiring rigid, predefined rules (relation/attribute) that may not suit specific user needs.

In many existing systems, the lack of unique identifiers for configuration items can lead to data duplication and confusion, compromising data integrity.

Further, Standardization and consistency in classification are often missing in current CI management systems, leading to unreliable and ineffective data management.

An invention described in Patent U.S. Pat. No. 8,639,798B2 addresses the management of multiple configuration items by utilizing a repository to store data about each item and a discovery section to detect information. However, the invention relies on manual processes for extracting and transforming data, which can be time-consuming and prone to human error. This often leads to inconsistent classification and storage of configuration items, making data retrieval and management difficult.

The patent application US20140297856A1 describes a system and a method for configuration management, focusing on tracking and managing changes to configuration items within a configuration management database (CMDB). The system lacks flexibility and customization options for managing the CIs.

The patent application US20150106320A1 outlines a configuration management system and method that includes a CMDB for storing information about configuration items and their relationships. Although it highlights the importance of maintaining accurate and up-to-date information, it relies more on manual processes for data extraction and transformation. This can lead to inefficiencies and inconsistencies in CI management.

Therefore, there is a need for a system or method or any such provisions for managing the CIs to overcome the above-mentioned problems.

An object of the present invention is to provide a system, a cloud platform, and a method for managing information of CIs of an IT infrastructure in a computing environment.

One more object of the present invention is to automate the extraction and transformation of data of the CI for reducing human error and increasing configuration management efficiency, ensuring consistent and accurate classification and storage of configuration items.

One more object of the present invention is to allow users to manage configuration items according to their specific requirements, ensuring accurate and relevant data transformation.

One more object of the present invention is to prevent duplication of CI data, and maintain data integrity, thereby enhancing reliability and consistency in the CI data handling.

One more object of the present invention is ensuring standardization and consistent classification, improving the reliability and effectiveness of data management of CI(s).

Other objects and advantages of the present disclosure will be more apparent from the following description, which is not intended to limit the scope of the present disclosure.

### SUMMARY OF THE INVENTION

The present invention addresses the inefficiency in managing Configuration Items (CIs) within IT infrastructures (can be cloud, hybrid, on prem), primarily caused by human error during manual data extraction and transformation. This issue leads to inconsistent classification and storage of CIs complicating data retrieval and management. The present invention provides a system, a cloud platform, and method that automate these processes to enhance management efficiency.

The system and the cloud platform include an extraction module that retrieves relevant data from various IT environments, a transformation layer that converts this data using static or configurable mapping rules and a modelling layer with classification rules and processing instructions for CI identification and classification. The bucketing layer of the system and the cloud platform compares transformed data with classifications and stores it in related storage pockets, forming datasets with classified CIs. Additionally, the invention features configurable mapping rulesets through user interfaces, unique identifiers for CIs to prevent duplication, and standardized classification methods based on industry's best practices.

The technical advantages of this invention include reducing human error, ensuring consistent and accurate classification and storage of CIs, enhancing data management efficiency, scalability, and flexibility. By automating data extraction and transformation.

The system and the cloud platform improve reliability and consistency in CI data handling, addressing issues of inconsistent classification that can lead to difficulties in data retrieval.

The method can be used to manage the CIs using the system or the cloud platform.

### BRIEF DESCRIPTION OF THE DRAWINGS

Reference will be made to embodiments of the invention, examples of which may be illustrated in accompanying figures. These figures are intended to be illustrative, not limiting. Although the invention is described in the context of these embodiments, it is not intended to limit the scope of the invention to these embodiments.

FIG. 1A shows a block diagram of a system for managing CIs in accordance with the present invention;

FIG. 1B shows a schematic diagram of a database and a bucketing layer of the system shown in FIG. 1A;

FIG. 1C shows one more schematic diagram of the database and the bucketing layer shown in FIG. 1B;

FIG. 2A shows a block diagram of a cloud platform for managing CIs in accordance with the present invention;

FIG. 2B shows a schematic diagram of a database and a bucketing layer of the cloud platform shown in FIG. 2A; and

FIG. 3 shows a flow chart of a method for managing CIs in accordance with the present invention.

### DETAILED DESCRIPTION OF THE INVENTION

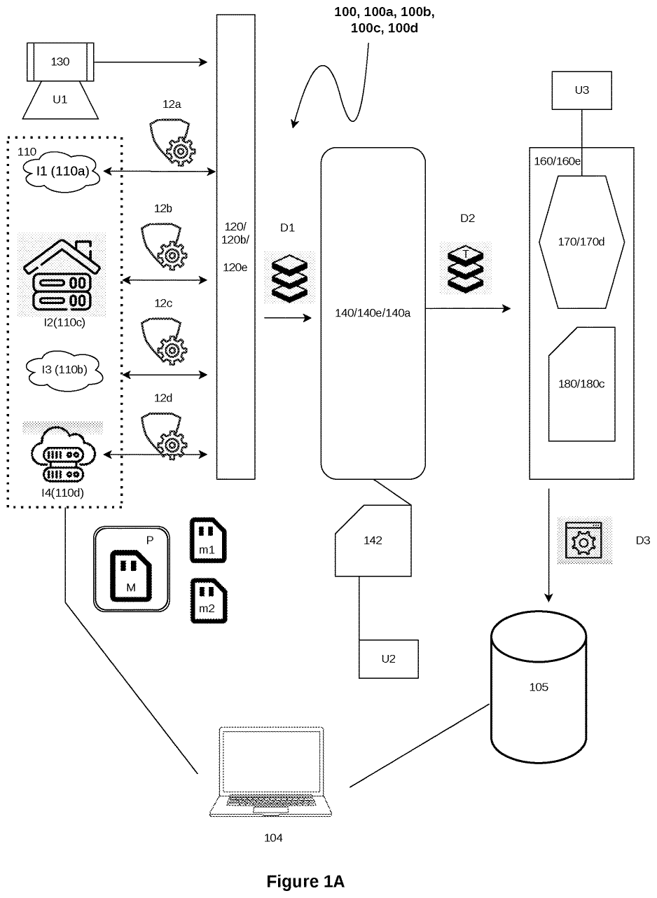

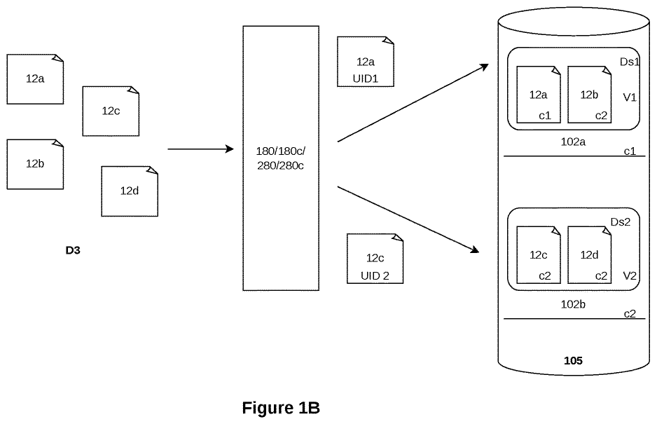

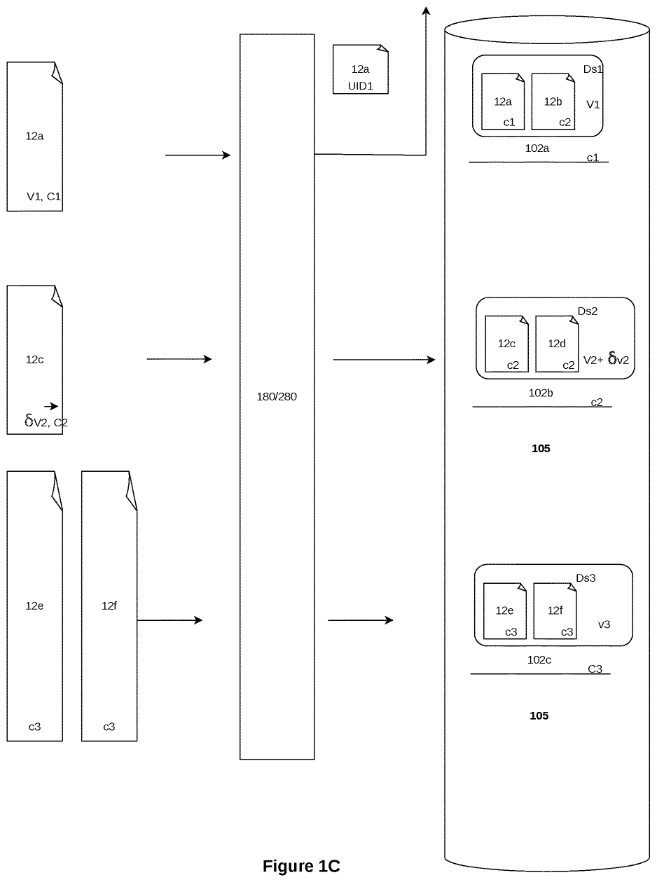

In an embodiment of the invention (FIG. 1A), the invention provides a system (100) for managing configuration items (12a, 12b, 12c, 12d) of a computing environment (110). The computing environment (110) has at least one hybrid computing environment (110d) or a cloud computing environment (110a, 110b) or an on-premises computing environment (110c). The computing environment (110) may have combinations of hybrid computing environments (110d) or cloud computing environments (110a, 110b) or an on-premises computing environment (110c). The system (100) includes at least one processor (P) having one or more memory units (m1, m2). The processor (P) can be processor of a computing device (104). The computing device (104) can be one of the computing devices (104) of the computing environment (110) which is adapted to perform a computing activity.

The memory unit (m1, m2) can be a memory unit which is operationally connected to the computing environment (110). The memory unit (m1, m2) can be permanent memory or a flash memory or RAM (Random Access Memory), Virtual Memory, Memory Virtualization, Cache Memory, Persistent Memory, Shared Memory. The computing device (104) can be a workstation or a laptop or a mobile or a virtual machine or any such electronic device/machine which is capable of performing a computing activity by receiving an input accordingly.

The computing environment has a database (105). The database has one or more storage pockets (102a, 102b) for storing the data. Each storage pocket (102a, 102b) is assigned with a CI classification (c1, c2). The CI classification is a fundamental aspect of configuration management, helping systematically manage and track their information technology assets. This classification can be predefined and redefinable.

The classification can include but not limited to Security Classification Codes, Sensitivity Codes, Demilitarization Codes and Unique Identifiers.

The system (100) has an extraction module (120), a transformation layer (140) and a modelling layer (160). The extraction module (120) is associated with one or more information infrastructure (I1, I2, I3) of the computing environment (110).

The Information infrastructure (I1, I2, I3) in the computing environment (110) includes essential components that work together (as a group) to support IT operations and services. The Information infrastructure (I1, I2, I3) may include servers, data centres, networking equipment such as routers, switches, hubs, desktop computers, and storage systems. Additionally, operating systems, application software, Content Management Systems (CMS), customer relationship management (CRM) systems, Enterprise Resource Planning (ERP) systems, and web servers play crucial roles. Physical facilities that house IT equipment and network cabling are also integral parts of the Information infrastructure (I1, I2, I3). The Information infrastructure (I1, I2, I3) enables efficient functioning and management of IT services.

The Configuration Items (CIs) encompass a wide range of components that need to be managed to ensure the smooth delivery of IT services. These include physical servers, which are crucial for computing and storage, networking devices such as routers, switches, and load balancers that facilitate data flow, and end-user devices like laptops and mobile phones that provide access to services and applications. Additionally, software components, including operating systems and application software, data centres, storage systems, content management systems (CMS), customer relationship management (CRM) systems, enterprise resource planning (ERP) systems, web servers and the like.

“Associated” here refers to operationally connected with the information infrastructure (I1, I2, I3). The extraction module (120) extracts the data (D1) of one or more configuration items (12a, 12b) from the respective information Technology (IT) infrastructure (I1, I2, I3). The extraction module (120) includes a set of hardware and a set of instructions (programs) to extract the data (D1) from a respective IT infrastructure (I1, I2, I3). The extraction module (120) is activated when a management activity of configuration item is initiated. The management activity can be initiated by a user by giving such input through a user interface (not shown) in the system (100). The management activity can be a service request for the computing environment (110). The management activity can be initiated due to an output from another computing activity of the computing environment (110).

The extraction module (120) has a set of plugin services to extract the data of the configuration items. The extraction module (120) may have discovery tools, such as SolarWinds and Lansweeper that scans the network to identify and list all connected devices and system, configuration Management Databases (CMDB), like ServiceNow and BMC Helix which serve as central repositories that store information about CIs and their relationships, Asset management systems including “IBM Maximo” (Trade name) and “Fresh service” (trade name) to track the lifecycle of IT assets from acquisition to disposal, Monitoring systems, such as Splunk and Nagios which continuously monitor the status and performance of CIs, Security tools like “Palo Alto” (Trade name), “Networks Cortex” (Trade name), “XDR” (Trade name) and Metasploit (Trade name) to ensure CIs are compliant with security policies and standards.

The extraction module (120) may also include physical components such as sensors which can monitor environmental conditions like temperature, humidity, and airflow within data centres, ensuring optimal operating conditions for hardware. Additionally, RFID (Radio Frequency Identification) tags and barcode scanners can be used to track physical assets and their locations. These physical components work alongside software tools to provide a comprehensive (complete) detail of the CIs of the IT infrastructure.

The plugin service can be prestored instruction or can be configured according to the computing environment (110). For example, for an AWS, an AWS plugin can be used. The extraction module (120) extracts the CI in real time or periodically as per the need of a user or for a managing activity.

Based on the input from a managing activity, the CI is extracted. For example, if a user initiates activity for CI (12a), the extraction module (120) retrieves data from the IT infrastructure (I1) of the cloud (110a). Similarly, when a user initiates activity for CI (12b), the extraction module extracts data from the IT infrastructure (I2) of the on-premises environment (110c). For CI (12c), the data is extracted from the IT infrastructure (I3) of the cloud (110b), and for CI (12d), the data is extracted from the IT infrastructure (I4) of the hybrid environment (110d).

It may be obvious to person skilled in the art to configure the extraction module (120) with a set of hardware and instructions to enable the extraction module (120) to extract the data of configuration items (12a, 12b) from the IT infrastructures (I1, I2, I3).

The transformation layer (140) is associated with the extraction module (120). The transformation layer (140) is a virtual layer or an activity of a virtual computing or a virtual service. The transformation layer (140) receives the extracted data (D1) from the extraction module (120). The transformation layer (140) is operationally connected to a relationship library (142). The relationship library (142) has a memory (m1) with prestored static mapping ruleset. The mapping ruleset has one or more rules to map the attributes of a CI (12a, 12b) and/or one or more relation(s) amongst the CIs (12a, 12b).

Mapping attributes of configuration items (CIs) (12a, 12b) involves associating specific characteristics and properties with each CI to facilitate effective management and tracking within an IT infrastructure (I1, I2). This process helps in understanding the relationships, dependencies, and interactions between different CIs. The Attributes can include details such as the CI's name, type, version, status, location, and relationships with other CIs.

Mapping the relation details of configuration items (CIs) involves identifying and documenting the connections and dependencies between different CIs within the IT infrastructure (I1, I2). The relations can include dependency relations, hierarchical relations, network relations, service relations, and operational relations.

The Relations details in configuration items (CIs) of IT infrastructure refer to the details of connections and dependencies between different components, which are crucial for understanding interactions and impacts. The relation may be a dependency relation that includes software dependencies, where applications rely on specific libraries or services, and hardware dependencies, where devices require components to function. Hierarchical relations involve parent-child relationships, such as servers encompassing virtual machines. Network relations cover connectivity and communication paths between network devices like routers and switches. Service relations include service dependencies, where services rely on other applications, and service impact, which shows how changes in one service affect others. Operational relations involve maintenance dependencies, impacting multiple CIs during scheduled activities, and performance dependencies, where the performance of one CI affects others in the infrastructure. Understanding these relations is essential for effective configuration management, optimizing performance, and ensuring seamless IT service operation.

For example, the extraction module (120) extracts raw data (D1) from an AWS cloud infrastructure (I1) comprising fields such as “InstanceId: i-0abc123”, “InstanceType: t2.micro”, “State: running”, and “LaunchTime: 2025-01-15”. The transformation layer (140) applies a static mapping ruleset from the relationship library (142) that maps “InstanceId” to a CI attribute “Name”, maps “InstanceType” to “Model”, maps “State” to “Status”, and maps “LaunchTime” to “DeploymentDate”. The mapping ruleset further defines a relation rule such as “If InstanceType contains ‘t2’ or ‘m5’, assign relation: parent=cmdb_ci_server”. The transformation layer (140) executes the mapping by performing a field-by-field lookup against the ruleset, applying string matching and conditional Boolean evaluation to produce the transformed data (D2) having standardized attributes: {Name: i-0abc123, Model: t2.micro, Status: Active, DeploymentDate: 2025-01-15, ParentClass: cmdb_ci_server}.

The transformation layer (140) transforms the extracted data (D1) into a transformed data (D2) with the one or more mapping ruleset(s). The transformation layer (140) identifies the extracted data (D1) and relates this data (D1) with the mapping rulesets. The related mapping rulesets are synchronized with the extracted data (D2). This synchronising can be performed by Boolean operations, complex data manipulation, retrieval, generation functions or any such obvious synchronizing or transformation operations.

The modelling layer (160) is associated With the transformation layer (140) for fetching the transformed data (D2). The modelling layer (160) has a data modelling layer (170) and a bucketing layer (180). The data modelling layer (170) has a set of classification rules and processing instructions for CI classifications (c1, c2) and identifications. The classification(s) (c1, c2) is (are) defined based on industry best practice, levels, relationships and attributes.

The identifications of CI such as unique identifier (UID), name, type, version, serial number, location, status and the like.

The data modelling layer (170) is a sub-processing operation with the classification rules and processing instructions for CI classifications (c1, c2) and identifications. The data modelling layer (170) can be a service operation or virtual processing operation.

The data modelling layer (170) stores classification rules as conditional rule statements, for example: “If CI attribute ‘Type’ equals ‘Server’ AND attribute ‘Environment’ equals ‘Production’, then classify as c1 (Production Server)”, or “If CI attribute ‘Type’ equals ‘Network Device’ AND attribute ‘SubType’ equals ‘Router’, then classify as c2 (Network Infrastructure)”. These rules are derived from industry best practices such as ITIL (Information Technology Infrastructure Library) classification frameworks and are encoded as machine-readable conditional expressions. The bucketing layer (180) compares the transformed data (D2) against these conditional rule statements by evaluating each rule sequentially or in a weighted priority order, and the first matching classification determines a storage pocket assignment. For variation detection, the bucketing layer (180) performs an attribute-by-attribute comparison of the incoming transformation data (D2) against the stored dataset (Ds1/Ds2) using the unique identifier or key attributes; if the unique identifier matches an existing CI but one or more attribute values differ, the difference is recorded as a variation (Δv), whereas if no matching identifier exists in any dataset, the CI is treated as a new entry.

The bucketing layer (180) includes a sub programme and stored in the memory (m) of the processor (P). The bucketing layer (180) compares the received transformed data (D2) with the CI classifications and identifications of the data modelling layer (170). Based on the results of the comparison, the bucketing layer (180) stores the compared data (D3) in the related storage pocket (102a, 102b) according to the classification (c1, c2).

For after comparing the CI (12a) (D3) with the CI classifications and identifications, if the CI (12a) belongs to class c1, the bucketing layer (180) stores the compared data (D3) in the storage pocket (102a) which is assigned with the class c1.

Similarly, after comparing the CI (12c) with the CI classifications and identifications, if the CI (12c) belongs to class c2, the bucketing layer (180) stores the compared data (12c) in the storage pocket (102b) which is assigned with the class c2.

Similarly, after comparing the CI (12b) with the CI classifications and identifications, if the CI (12b) belongs to class c1, the bucketing layer (180) stores the compared data (12b) in the storage pocket (102a) which is assigned with the class c1.

Similarly, after comparing the CI (12d) with the CI classifications and identifications, if the CI (12d) belongs to class c2, the bucketing layer (180) stores the compared data (12d) in the storage pocket (102b) which is assigned with the class c2.

The bucketing layer forms a dataset (Ds1/Ds2) having at least two CI's (12a, 12b) classified under one (same) classification (c1/c2). For example, if the CIs (12a and 12b) belong to classification c1, the bucketing layer (180) forms a dataset (Ds1) in the storage pocket (102a). Similarly, if the CIs (12c and 12d) belong to classification c2, the bucketing layer (180) forms a dataset (Ds2) in the storage pocket (102b).

Configuration Items (CIs) (12a, 12b) in a Configuration Management Database (CMDB) have various attribute values that define their characteristics and relationships. These attribute values include essential details such as the name, description, and default values of the CI. Each CI type inherits attributes from its parent CI type, ensuring consistency and hierarchy within the CMDB. For example, a CI type like “Server” might have attributes such as model, service tag, IP address, and processor speed. Additionally, identification methods are used to distinguish different instances of the same CI type, often involving key attributes that serve as unique identifiers. These attributes are crucial for managing and tracking the configuration items effectively within an organization.

Further, the bucketing layer (180) moves and stores the compared data (D3) into the datasets (Ds1, Ds2) stored in the database (105) according to the attribute values (V1, V2, V3).

More specifically, if the compared data (D3) has the same attribute values (V1) as that of CIs of the stored dataset (Ds1/Ds2), the compared data (D3) is not stored in the storage pocket(s) (102a, 102b) of the database (105). In the example shown in FIG. 1C, the CI (12a) has attribute value of V1 and belongs to classification c1 which is a compared data D3. There is already a dataset (Ds1) with the CI (12a) having attribute value V1. Therefore, bucketing layer (180) will not add D3 that is CI (12a) with the V1 to the dataset (Ds1) or to any dataset(s) of the database (105).

Similarly, if the compared data (D3) has variations (Δv) in attribute values (V1) as that CIs of the stored dataset (Ds1/Ds2), the bucketing layer (180) adds the details of the variations (Δv) to the respective dataset (Ds1/Ds2). In the example shown in FIG. 1C, the CI (12c) has attribute value of δv2 (delta v2) that is variation from V2 and belongs to classification c2 which is a compared data D3. There is already the stored dataset (Ds2) with the CI (12) having attribute value V2. Therefore, the bucketing layer (180) adds the details of the variations (Δv) to the respective dataset (Ds2) make the dataset (Ds2) to (Ds2) with v2+δv2. Any consecutive variation will be added to the datasets (Ds1+Ds2) accordingly upon receiving CI with variation(s) to the previous attribute values of the datasets (Ds1, Ds2).

Similarly, if the compared data (D3) belongs to a classification if the storage pocket with the classification is absent, the bucketing layer (180) creates a storage pocket with the classification and stores the compared data (D3) in the created storage pocket. In the example shown in FIG. 1C, the CI (12e and 12f) belongs to class c3. There is an absence of storage pocket with class c3 in the database (105). When the bucketing layer (180) receives CI (12e) and CI (12f) as compared to data D3, the bucketing layer (180) creates the storage pockets (102c) assigned with classification (C3). The bucketing layer (180) is a set of instructions (sub programs) to create the storage pockets (102c) according to a trigger. The trigger is the condition of receipt of CI with class which is not previously available in the database (105).

Further, the bucketing layer (180) moves the CI (12e) and CI (12f) to the storage pocket (102c) and stores therein. Further, a dataset (Ds3) is formed in the storage pocket (102c) as the CIs (12e and 12f) belong to same class (c3). The dataset (Ds3) may have attribute value v3.

Similarly, the bucketing layer (180) moves and stores the compared data (D3) in the database (105). In one more embodiment (100a) of the system (100), the system (100a) has a second user interface (U2) and a relationship library (142a). The second user interface (U2) is connected to the relationship library (142a). The functioning of the relationship library (142a) is the same as the relationship library (142) of the system (100). A user can configure a configurable mapping ruleset in the system (100) through the second user interface (U2). The configured mapping ruleset has mapping of one or more attributes of a CI (12a, 12b) and/or one or more relation details amongst the CIs (12a, 12b). It may be obvious to a person skilled in the art to configure the second user interface (U2) for receiving user inputs as configurable mapping ruleset. The second user interface (U2) can be a user interface of a computing device (not shown) of the system (100a).

The bucketing layer (180c) assigns the unique identifier (UID1, UID2) by applying identification rules that evaluate a combination of key attributes of the CI, such as serial number, IP address, and hostname, to generate a composite unique key. The Identification and Reconciliation Engine compares this composite key against all existing UIDs in the database (105); if an exact match is found, the incoming CI is reconciled with the existing record and any attribute variations are updated, and if no match is found, a new UID is assigned and the CI is stored as a new entry. The reconciliation logic resolves conflicts arising from multiple data sources reporting the same CI with slightly different attributes by prioritizing attributes from the most authoritative source as defined in a configurable source priority list.

In one more embodiment (100b) of the system (100), the system (100b) has an extraction module (120b) which is associated with a user configuration input (130). The user configuration input (130) can be configured by a user by a first user interface (U1) of the system (100b). The first user interface (U1) can be a user interface of a computing device (not shown) of the system (100b). The first user interface (U1) has a set of sub program(s) or a modeling layout or any such obvious provisions for enabling the user to configure the CIs therethrough. The functioning of the extraction module (120b) is the same as of extraction module (120) of the system (100).

In one more embodiment (100c) of the system (100), the system (100c) has a bucketing layer (180c). The bucketing layer (180c) assigns a unique identifier (UID1, UID2) to each compared data (D3) having one CI (12a) therein. The bucketing layer (180c) has a set of sub-programs to add a unique identifier (UID1) to the data (D3) compared with one CI (12a/12b). The bucketing layer (180c) may use Identification and Reconciliation Engine data from various sources and applies identification rules to ensure each CI (12a, 12b) is uniquely identified and reconciled. The functioning of the bucketing layer (180c) is the same as that of the bucketing layer (180) of the system (100).

In one more embodiment (100d) of the system (100), the system (100d) has a third user interface (U3). The third user interface (U3) is connected to a data modelling layer (170d). The functions and connections of the data modelling layer (170d) are the same as that of data modelling layer (170). A user can define the classifications (c1, c2) through the third user interface (U3). The classification (c1, c2) can be based on industry's best practice, levels, relationships, and attributes. The classification (c1, c2) can include class code, class name, class identifiers, super classes (having subclasses therein) or such. The levels can be a comparative classification.

In a Configuration Management Database (CMDB), Configuration Items (CIs) are classified into various hierarchical levels to organize and manage them effectively. At the top level, broad categories such as cmdb_ci and cmdb_ci_service encompass a wide range of CIs, providing a general framework for classification. Mid-level classes, like cmdb_ci_computer and cmdb_ci_network, offer more specific categories, covering types of computers and network devices, respectively.

At the lowest level, highly detailed classes such as cmdb_ci_server and cmdb_ci_application provide granular attributes for types of CIs, including servers with specifications like CPU, RAM, and storage, and software applications with details like version and license. This hierarchical structure ensures systematic organization, efficient management, and accurate tracking of CIs within the CMDB. Similarly various classes can be defined according to the levels, the attributes, and the relationships.

The stored data sets (Ds1, Ds2) of the database (105) can be viewed through a display of the computing device of the computing environment. The stored data sets (Ds1, Ds2) can also be used for any CI management activity. The data stored datasets (Ds1, Ds2) can be used as input for any computing service or any such requirement.

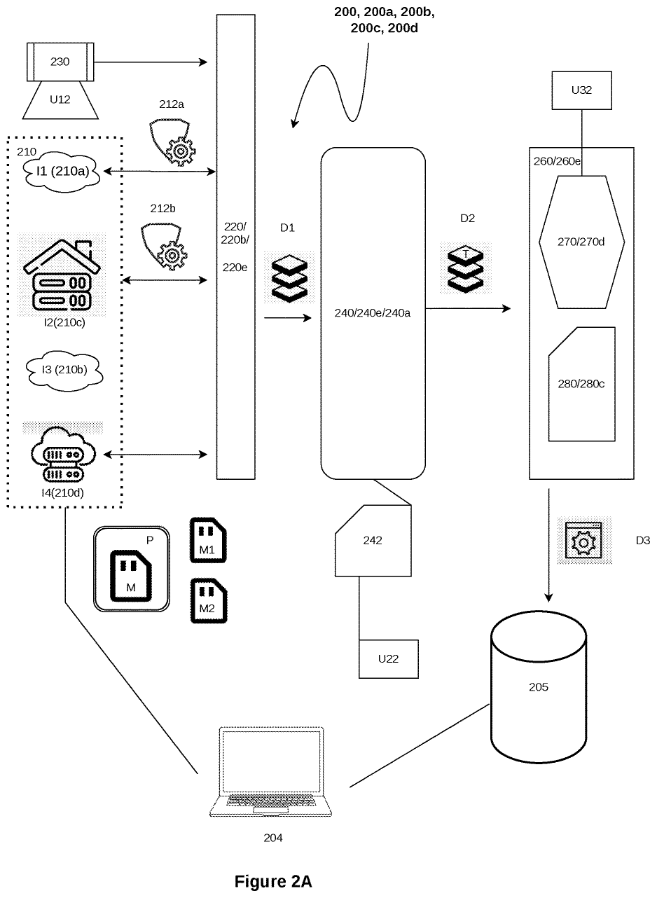

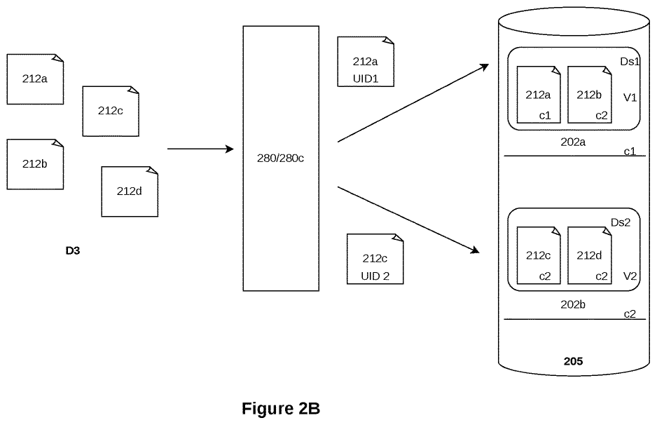

In one more embodiment of the invention a cloud platform (200) for managing CIs as a SaaS implementation is provided. The cloud platform (200) manages configuration items (212a, 212b) of a computing environment (210) (FIG. 2A). The computing environment (210) has a database (205) (FIG. 2B) with one or more storage pockets (202a, 202b) therein. Each storage pocket (202a, 202b) is assigned with the CI classification (c1, c2). The cloud platform (200) has a processor (P) and a memory (m). The processor can be processor of a computing device of the computing environment (210). The memory can be flash memory or any such memory for facilitating SaaS based operations of the cloud platform (200).

The cloud platform (200) has an extraction module (220), a transformation layer (240) and a modelling layer (260) as SaaS applications prestored in the memory (m).

The extraction module (220) is associated with one or more information infrastructure (I1, I2, I3) of the computing environment (210) to extract data of one or more configuration items (212a, 212b) from the respective information infrastructure (I1, I2, I3). Functioning and connection of the extraction module (220) is the same as the extraction module (120) of the system (100).

The transformation layer (240) is associated with the extraction module (220) to transform the extracted data (D1) into a transformed data (D2) with one or more mapping ruleset(s). Functioning and connection of the transformation layer (240) is the same as the transformation layer (140) of the system (100). The mapping ruleset is a prestored static ruleset in a memory (m1) of the cloud platform (200) and the static mapping ruleset has mapping of one or more attributes of a CI (212a, 212b) and/or one or more relation details amongst the CIs (212a, 212b).

The modelling layer (260) is associated with the transformation layer (240) for fetching the transformed data (D2). The modelling layer (260) includes a data modelling layer (270) with a set of classification rules and processing instructions for CI classifications and identifications; and a bucketing layer (280) associated with the data modelling layer (270). The bucketing layer (280) fetches the transformed data (D2). Further, the bucketing layer (280) compares the received transformed data (D2) with the CI classifications and identifications of the data modelling layer (270) and stores the compared data (D3) in the related storage pocket (202a, 202b) according to the classification (c1, c2). Also, the bucketing layer forms a dataset (Ds1) having at least two CI's (212a, 212b) classified under classification (c1/c2). Functioning and connections of the modelling layer (260) are the same as the modelling layer (160) of the system (100).

Further, if the compared data (D3) has same the attribute values (V1) as that of CIs of the stored dataset (Ds1/Ds2), the compared data (D3) is not stored in the storage pocket(s) (202a, 202b) of the database (205).

Similarly, if the compared data (D3) has variations (Δv) (not shown) in attribute values (V1) as that CIs of the stored dataset (Ds1/Ds2), the bucketing layer (280) adds the details of the variations (Δv) to the respective dataset (Ds1/Ds2).

Similarly, if the compared data (D3) belongs to a classification, there is an absence of the storage pocket with the classification, the bucketing layer (280) creates a storage pocket with the classification and stores the compared data (D3) in the created storage pocket.

In one more embodiment (200a) of the cloud platform (200), the cloud platform (200a) has a second user interface (U22) and a relationship library (242a). The second user interface (U22) is connected to the relationship library (242a). The functioning of the relationship library (242a) is the same as the relationship library (242a) of the cloud platform (200). A user can configure a configurable mapping ruleset in the cloud platform (200a) through the second user interface (U22). The configured mapping ruleset has mapping of one or more attributes of a CI (12a, 12b) and/or one or more relation details amongst the CIs (12a, 12b). The functioning and connection of the second user interface (U22) of the cloud platform (200a) is the same as of the second user interface (U2) of the system (100a). Mapping of the configurable ruleset is enabled as SaaS operation in the cloud platform (200a) or in any computing device connected to the cloud platform (200a).

In one more embodiment (200b) of the cloud platform (200), the cloud platform (200b) has an extraction module (220b) which is associated with a user configuration input (230). The user configuration input (230) can be configured by a user by a first user interface (U12) of the system (100b). The functioning of the extraction module (220b) is the same as the extraction module (220) of the cloud platform (200). The functioning and connection of the first user interface (U12) of the cloud platform (200a) is the same as of the first user interface (U1) of the system (100b). Configuring the CI in the user interface (U12) is enabled as a SaaS operation in the cloud platform (200b) or in any computing device connected to the cloud platform (200b).

In one more embodiment (200c) of the cloud platform (200), the cloud platform (200c) has a bucketing layer (280c). The bucketing layer (280c) assigns a unique identifier (UID1, UID2) to each compared data (D3) having one CI (12a) therein. The functioning of the bucketing layer (280c) is the same as that of the bucketing layer (280) of the cloud platform (200). Also, the functioning of the bucketing layer (280c) is the same as that of the bucketing layer (180c) of the system (100c).

In one more embodiment (200d) of the cloud platform (200), the cloud platform (200d) has a third user interface (U32). The third user interface (U32) is connected to a data modelling layer (270d). The functions and connections of the data modelling layer (270d) are the same as that of data modelling layer (270) of the cloud platform (200). A user can define the classifications (c1, c2) through the third user interface (U32). The functioning of the third user interface (U32) is the same as that of third user interface (U3) of the system (100d). Defining the classification in the cloud platform (200d) of is enabled as SaaS operation in the cloud platform (200d) or in any computing device connected to the cloud platform (200d).

The stored data sets (Ds1, Ds2) of the database (205) can be viewed through a display of the computing device (204) of the computing environment (210) to which the cloud platform (200) is connected. The stored data sets (Ds1, Ds2) of the database (205) can also be used for any CI management activity. The stored data of datasets (Ds1, Ds2) of the database (205) can be used as input for any computing service or any such requirement or any SaaS operation related. The details of the datasets (Ds1, Ds2) also retrieved as SaaS services through the cloud platform (200).

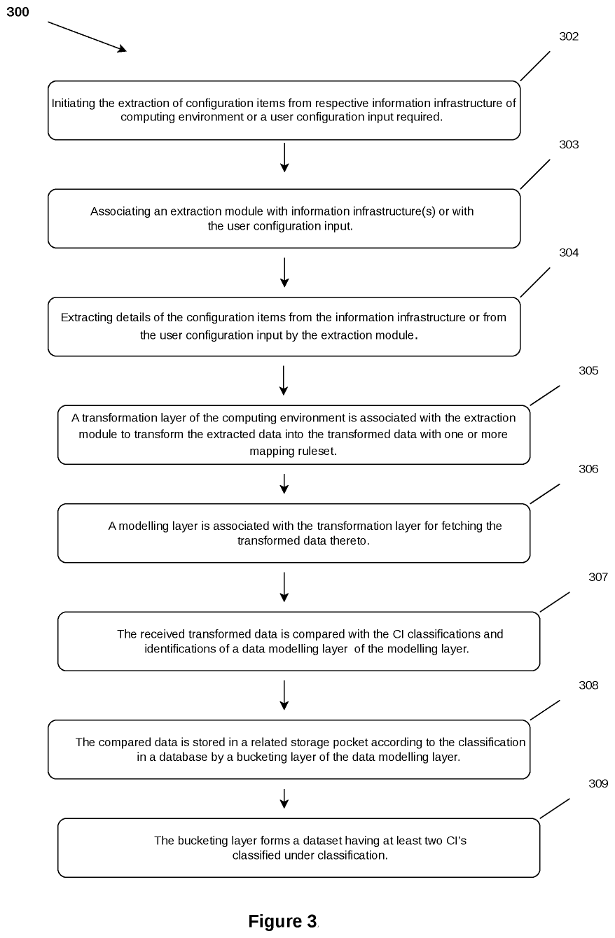

In one more embodiment of the invention, a method (300) (FIG. 3) of managing the configuration items (12a, 212a) of the computing environment (110, 210) is provided in accordance with the present invention.

At step 302, extraction of the required CI's (12a, 12b) of the information infrastructure (I1, I2) of the computing environment (110, 210) for a CI management activity is initiated. The initiation is executed by providing an input through a user interface (not shown) of the computing environment (110, 210). The user interface can be a user interface of the cloud platform (200) (the system (100) or the cloud platform (200)).

At step 303, the extraction module (120/220) of the computing environment (110, 210) is associated with the information infrastructure(s) (I1, I2, I3) of the computing environment (110, 210) or with the user configuration input (230,130) of the computing environment (110, 210).

At step 304, the data of the configuration items (12a, 12b) from the respective information infrastructure (I1, I2, I3) is extracted by the extraction module (120).

At step 305, the transformation layer (140, 240) of the computing environment (110, 210) is associated with the extraction module (120) to transform the extracted data (D1) into the transformed data (D2) with the mapping ruleset(s).

At step 306, the modelling layer (160, 260) of the computing environment (110, 210) is associated with the transformation layer (140, 240) for fetching the transformed data (D2) thereto.

At step 307, the received transformed data (D2) is compared with the CI classifications and identifications of the data modelling layer (170, 270) of the modelling layer (170, 270).

At step 308, the compared data (D3) is stored in the related storage pocket (102a, 202a) according to the classification (c1, c2) in the database (105, 205) of the computing environment (110, 210) by the bucketing layer (180, 280) of the data modelling layer (170, 270).

At step 309, the bucketing layer forms the dataset (Ds1/Ds2) having at least two CI's (12a, 212b) classified under classification (c1/c2).

### Application (Implementation)

Depends upon a requirement of a CI management activity, a user can configure the present invention as the system (100) where the components of the invention such as the extraction module (120/120b), the transformation layer (140), the modelling layer (160) are stored (configured) in the existing computing environment (110) for extracting CI details from the information infrastructure (I1, I2) for a specific configuration management activity.

The invention can be configured as the system (100a) if a user needs to make the system (100) for configurable mapping ruleset(s) which enables the user to configure the configurable (dynamic) mapping ruleset of relations and attributes.

The invention can be configured as the system (100b) if a user needs to make the system (100) for managing configuration items which are configured from the user. With the system (100b), the user can make certain configuration items, and the configuration items managed (by the system (100)) can be stored in the database (105).

If a user requires to add unique identifier (UID1, UID2) to configuration items, the system (100) be configured as the system (100c).

If a user requires to define classification based on defined based on industry best practice, levels, relationships and attributes, the system (100) be configured as the system (100d).

The invention can be configured as the cloud platform (200) which is associated with the cloud computing environment (210). The cloud platform (200) manages the CI of the computing environment (210).

The invention can be configured as the cloud platform (200a) if a user needs to make the cloud platform (200) for configurable mapping ruleset(s) which enables the user to configure the configurable (dynamic) mapping ruleset of relations and attributes.

The invention can be configured as the cloud platform (200b) if a user needs to make the cloud platform (200) for managing the configuration items which are configured from the user. computing environment (210)If a user requires to define classification based on defined based on industry best practice, levels, relationships, and attributes in the cloud computing environment (210), the cloud platform (200) be configured as the cloud platform (200d).

The invention can be implemented as the method (300), the method (300) can be performed as a method of managing CIs both in the system (100) and the cloud platform (200).

### Technical Advantages

The Present invention (the system (100) and the cloud platform (200)) has the extraction module (120/220), the transformation layer (140/240), the modelling layer (160/260), the data modelling layer (170/270) and the bucketing layer (180/280) which makes the present invention (100/200) to efficiently extract the details of configuration items from any type of computing environment (cloud, on prem or hybrid) and process these details and stores in the database (105/205) systematically without much human intervention.

The present invention (100/200) has the advantage of automating data extraction and transformation, reducing human error and increasing configuration management efficiency. The invention (100/200) ensures consistent and accurate classification and storage of configuration items, addressing issues of inconsistent classification and storage that can lead to difficulties in data retrieval and management. Additionally, the bucketing layer (180/280) organizes data into the classified storage pockets (102a, 202a), improving data management and accessibility. The modular design (with layers and modules) of the invention (100/200) allows for scalability and flexibility, accommodating growing data needs and evolving infrastructure. Overall, the invention (100/200) addresses user's problems by automating processes, ensuring consistent classification, and improving data management and accessibility, while offering scalability and flexibility.

One of the embodiments of the invention is the system (100a) and the cloud platform (200a) has the advantage of providing a user with a provision of the mapping configurable ruleset(s) through the second user interface (U2/U22). The configurable mapping ruleset allows users to manage the CI's as per the user's requirement, ensuring accurate and relevant data transformation.

One more embodiment of the invention (that is the system (100c) and the cloud platform (200c)) has the advantage of assigning the unique identifier (UID1, UID2) to each compared data (D3) having one CI (12a, 220a). The Unique identifiers (UID1, UID2) maintain data integrity by preventing (avoiding) duplication and ensuring each configuration item is distinctly recognized, enhancing reliability and consistency in data handling.

One more embodiment of the invention (that is the system (100d) and the cloud platform (200d)) has advantage of providing the third user interface (U32/U3) to enable a user to define the classification (c1, c2) based on industry best practice, levels, relationships and attributes. Defining classifications based on industry best practices ensure standardization and consistency, improving the reliability and effectiveness of data management.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

All third-party trademarks, service marks, trade names, or product names appearing in this specification are the property of their respective owners. They are used solely for identification, descriptive, or illustrative purposes to demonstrate interoperability or compatibility with the systems, platforms, or services referenced herein. Such use does not imply any affiliation, endorsement, or relationship between the applicant and the respective trademark owners. All rights in the referenced trademarks are hereby acknowledged.

All copyrighted materials, technical specifications, software code, and intellectual property referenced herein remain the property of their respective copyright holders. Such materials are referenced solely for technical illustration or comparative analysis without implying any license grant, authorization, or relationship between the applicant and respective owners. No copyrighted content has been reproduced or incorporated into this specification.

1. A system (100) for managing configuration items (12a, 12b) of a computing environment (110) having a database (105) with one or more storage pockets (102a, 102b) therein, each storage pocket (102a, 102b) is assigned with a CI (configuration item) classification (c1, c2) thereto, the system (100) comprises: at least one processor (P) having one or more memory units (M1, M2) associated therewith;
an extraction module (120/120b) associated with one or more information infrastructure (I1, I2, I3) of the computing environment (110) or with a user configuration input (130), the extraction module (120) extracts data of one or more configuration items (12a, 12b) from the respective information infrastructure (I1, I2, I3);
a transformation layer (140) is associated with the extraction module (120) to transform the extracted data (D1) into a transformed data (D2) with one or more mapping ruleset (s); and
a modelling layer (160) associated with the transformation layer (140) for fetching the transformed data (D2), the modelling layer (160) includes:
a data modelling layer (170) with a set of classification rules and processing instructions for CI classifications and identifications; and
a bucketing layer (180) associated with the data modelling layer (170); wherein the bucketing layer (180) fetches the transformed data (D2), and the bucketing layer (180) compares the received transformed data (D2) with the CI classifications and identifications of the data modelling layer (170); and stores the compared data (D3) in the related storage pocket (102a, 102b) according to the classification (c1, c2), wherein the bucketing layer forms a dataset (Ds1/Ds2) having at least two CI's (12a, 12b) classified under one classification (c1/c2).

2. The system (100) of claim 1, wherein
a. if the compared data (D3) has the same attribute values (V1) as that of CIs of the stored dataset (Ds1/Ds2), the compared data (D3) is not stored in the storage pocket(s) (102a, 102b) of the database (105);
b. if the compared data (D3) has variations (Δv) in attribute values (V1) as that of CIs of the stored dataset (Ds1/Ds2), the bucketing layer (180) adds the details of the variations (Δv) to the respective dataset (Ds1/Ds2); or
c. if the compared data (D3) belongs to a classification, there is an absence the storage pocket with the classification, the bucketing layer (180) creates a storage pocket with the classification and stores the compared data (D3) in the created storage pocket.

3. The system (100) of claim 1, wherein the mapping ruleset is a prestored static ruleset in a memory (m1) of the system (100) and the static mapping ruleset has mapping of one or more attributes of a CI (12a, 12b) and/or one or more relation details amongst the CIs (12a, 12b).

4. The system (100a) of claim 1, wherein the mapping ruleset is a configurable ruleset(s) through a second user interface (U2) of a system(100a), the configured mapping ruleset has mapping of one or more attributes of CI (12a, 12b) and/or one or more relation details amongst the CIs (12a, 12b).

5. The system (100b) of claim 1, wherein the user configuration input (130) can be configured by a user by a first user interface (U1) of the system (100b) and the bucketing layer (180c) assigns a unique identifier (UID1, UID2) to each compared data (D3) with the one CI (12a) therein and the classifications (c1, c2) are defined by a third user interface (U3) of the system (100d).

6. A cloud platform (200) for managing configuration items (212a, 212b) of a computing environment (210) having a database (205) with one or more storage pockets (202a, 202b) therein, the cloud platform (200) has at least one processor (P) having one or more memory units (M1, M2) and each storage pocket (202a, 202b) is assigned with a CI classification (c1, c2) thereto, the cloud platform(200) comprises:
an extraction module (220) associated with one or more information infrastructure (I1, I2, I3) of the computing environment (210) or with a user configuration input (230), the extraction module (220) extracts data of one or more configuration items (212a, 212b) from the respective information infrastructure (I1, I2, I3);
a transformation layer (240) is associated with the extraction module (220) to transform the extracted data (D1) into a transformed data (D2) with one or more mapping ruleset (s); and
a modelling layer (260) associated with the transformation layer (240) for fetching the transformed data (D2), the modelling layer (260) includes:
a data modelling layer (270) with a set of classification rules and processing instructions for CI classifications and identifications; and
a bucketing layer (280) associated with the data modelling layer (270); wherein the bucketing layer (280) fetches the transformed data (D2), and the bucketing layer (280) compares the received transformed data (D2) with the CI classifications and identifications of the data modelling layer (270); and stores the compared data (D3) in the related storage pocket (202a, 202b) according to the classification (c1, c2);
wherein the bucketing layer forms a dataset (Ds1) having at least two CI's (212a, 212b) classified under classification (c1/c2).

7. The cloud platform (200) of claim 6, wherein
a. if the compared data (D3) has the same attribute values (V1) as that of CIs of the stored dataset (Ds1/Ds2), the compared data (D3) is not stored in the storage pocket(s) (202a, 202b) of the database (205);
b. if the compared data (D3) has variations (Δv) in attribute values (V1) as that of CIs of the stored dataset (Ds1/Ds2), the bucketing layer (280) adds the details of the variations (Δv) to the respective dataset (Ds1/Ds2); or
c. if the compared data (D3) belongs to a classification, there is an absence the storage pocket with the classification, the bucketing layer (280) creates a storage pocket with the classification and stores the compared data (D3) in the created storage pocket.

8. The cloud platform (200) of claim 6, wherein the mapping ruleset is a prestored static ruleset in a memory (m1) of the cloud platform (200) and the static mapping ruleset has mapping of one or more attributes of a CI (212a, 212b) and/or one or more relation details amongst the CIs (212a, 212b).

9. The cloud platform (200a) of claim 6, wherein the mapping ruleset is a configurable ruleset(s) through a second user interface (U22) of a cloud platform (200a), the configured mapping ruleset has mapping of one or more attributes of CI (212a, 212b) and/or one or more relation details amongst the CIs (212a, 212b).

10. The cloud platform (200b) of claim 6, wherein the user configuration input (230) can be configured by a user by a first user interface (U12) of the cloud platform (200b), the bucketing layer (280c) assigns a unique identifier (UID1, UID2) to each compared data (D3) with the one CI (212a) therein and the classifications (c1, c2) is defined by a third user interface (U32) of the cloud platform (200d).

11. A method (300) of managing configuration items (12a,12b or 212a, 212b) of a computing environment (110 or 210), the method (300) comprises steps of:
initiating extraction of CI's (12a, 12bor 212a, 212b) of information infrastructures (I1, I2) of the computing environment (110 or 210) by providing an input through a user interface of the computing environment (110 or 210) accordingly;
associating an extraction module (120 or 220) of the computing environment (110 or 210) with one or more information infrastructure (I1, I2, I3) of the computing environment (110 or 210) or with a user configuration input (230,130) of the computing environment (110 or 210);
extracting data of one or more configuration items (12a 12b or 212a, 212b) from the respective information infrastructure (I1, I2, I3) by the extraction module (120 or 220);
associating a transformation layer (140 or 240) of the computing environment (110 or 210) with the extraction module (120 or 220) to transform the extracted data (D1) into a transformed data (D2) with one or more mapping ruleset (s);
associating a modelling layer (160 or 260) of the computing environment (110 or 210) with the transformation layer (140 or 240) for fetching the transformed data (D2) thereto;
comparing the received transformed data (D2) with the CI classifications and identifications of a data modelling layer (170 or 270) of the modelling layer (160 or 260) and storing the compared data (D3) in a related storage pocket (102a or 202a) according to the classification (c1, c2) in a database (105 or 205) of the computing environment (110 or 210) by a bucketing layer (180 or 280) of the data modelling layer (170 or 270); and the bucketing layer forms a dataset (Ds1) having at least two CI's (12a, 12b) classified under classification (c1, c2).

12. The cloud platform of claim 6, wherein the extraction module is activated when a CI management activity is initiated, the CI management activity being initiated by at least one of: (a) a user input provided through a user interface of the computing environment; (b) a service request for the computing environment; or (c) an output from another computing activity of the computing environment; and wherein the extraction module extracts data of the configuration items in real-time or periodically as per the need of a user or the CI management activity.

13. The cloud platform of claim 6, wherein the extraction module comprises: (a) a set of plugin services to extract data of the configuration items, each plugin service being pre-stored or configured according to the respective computing environment; and (b) one or more physical components including at least one of sensors for monitoring environmental conditions, RFID (Radio Frequency Identification) tags, or barcode scanners, for tracking physical assets and their locations within the information infrastructure, the physical components working to provide comprehensive details of the configuration items.

14. The cloud platform of claim 6, wherein the bucketing layer, upon receiving the compared data: (a) does not store the compared data in the storage pocket(s) of the database, if the compared data has same attribute values as that of CIs of the stored dataset ; (b) adds details of each consecutive variation (Δv) to the respective dataset, updating the attribute values of the dataset accordingly, if the compared data has variations in attribute values as that of CIs of the stored dataset; or (c) creates a storage pocket with the classification and stores the compared data in the created storage pocket, upon a trigger condition of receipt of a CI with a classification not previously available in the database.

15. The cloud platform of claim 6, wherein: (a) the data modelling layer implements a hierarchical classification structure comprising a top level having broad CI categories, one or more mid-levels having specific CI type categories, and a lowest level having granular CI classes with detailed attributes and (b) the CI classifications assigned to each storage pocket are predefined and redefinable.

16. The cloud platform of claim 6, wherein the bucketing layer uses an Identification and Reconciliation Engine that applies identification rules to ensure each configuration item is uniquely identified and reconciled from various data sources to enable assignment of the unique identifier; and wherein the stored datasets of the database are: (a) viewable through a display of a computing device of the computing environment to which the cloud platform is connected; and (b) usable as input for any computing service, any CI management activity, or any SaaS operation related to the cloud platform.

17. The cloud platform of claim 6, wherein the cloud platform manages configuration items across a combination of computing environments comprising at least one of a cloud computing environment, an on-premises computing environment or a hybrid computing environment with plugin services configured according to the respective computing environment; and wherein each of the following operations is enabled as a SaaS operation in the cloud platform or in any computing device connected to the cloud platform: (a) configuring a mapping ruleset of one or more attributes of a CI and/or one or more relation details amongst the CIs through a user interface; (b) configuring user-defined configuration items through a user interface; (c) assigning a unique identifier to each configuration item; and (d) defining CI classifications based on industry best practices, levels, relationships, and attributes.

18. The method of claim 11, wherein the method is implemented as a Software-as-a-Service (SaaS) operation in a cloud platform (200) or in any computing device connected to the cloud platform (200), the method further comprising:
enabling, through the cloud platform (200), at least one of the following as a SaaS operation:
(a) configuring a mapping ruleset of one or more attributes of a configuration item (12a, 12b or 212a, 212b) and/or one or more relation details amongst the configuration items (12a, 12b or 212a, 212b) through a user interface connected to the cloud platform (200);
(b) configuring user-defined configuration items through a user interface connected to the cloud platform (200);
(c) assigning a unique identifier (UID1, UID2) to each compared data (D3) of a configuration item to prevent duplication and ensure distinct recognition; and
(d) defining CI classifications (c1, c2) based on industry best practices, levels, relationships, and attributes through a user interface connected to the cloud platform (200);
wherein the computing environment (110 or 210) comprises at least one of a cloud computing environment, an on-premises computing environment, or a hybrid computing environment, and the plugin services of the extraction module (120 or 220) are configured according to the respective computing environment.
